(19) United States
(12) Patent Application Publication
(10) Pub. No.: US 2022/0077446 A1
(43) Pub. Date: Mar. 10, 2022

(54) ELECTRODE MANUFACTURING APPARATUS

(71) Applicant: JTEKT CORPORATION, Kariya-shi (JP)

(72) Inventors: Takaya NAGAHAMA, Obu-shi (JP); Takashi MIZOGUCHI, Kariya-shi (JP); Sho HASEGAWA, Kariya-shi (JP); Keisuke USUDA, Nagoya-shi (JP)

(73) Assignee: JTEKT CORPORATION, Kariya-shi (JP)

(21) Appl. No.: 17/446,731

(22) Filed: Sep. 2, 2021

(30) Foreign Application Priority Data
Sep. 7, 2020 (JP) 2020-149701

(51) Int. Cl. H01M 4/04

(52) U.S. Cl. CPC H01M 4/0435

(57) ABSTRACT

There is provided an electrode manufacturing apparatus configured to manufacture an electrode in which an active material layer is formed on at least one surface of a metal foil, the electrode manufacturing apparatus including: a press unit configured to press, by a function surface of a press roller, the metal foil on which the active material layer is formed. The press unit includes the press roller having: a base material; and the functional surface that is formed on an outer circumferential surface of the base material and that is formed with a fine structure imparting a liquid repellency.

### CROSS-REFERENCE TO RELATED APPLICATIONS

This application is based on and claims priority under 35 USC 119 from Japanese Patent Application No. 2020-149701 filed on Sep. 7, 2020, the contents of which are incorporated herein by reference.

### TECHNICAL FIELD

The present disclosure relates to an electrode manufacturing apparatus.

### BACKGROUND ART

For example, in manufacturing of a power storage device such as a lithium ion secondary battery, a metal foil having an active material layer formed thereon as an electrode is used. In the related art, as a method for forming the active material layer on the metal foil, there is a method of applying, to the metal foil, a slurry in which an active material or the like is dispersed in a solvent, evaporating the solvent by a drying process, and then performing pressing by a press roll (See, for example, JP2015-149236A).

In the related-art technique, in the process of performing pressing with the press roll, an active material or the like may adhere to the press roll. In this case, various problems may occur due to the active material or the like adhering to the press roller becoming a foreign matter and being deposited. For example, when the pressing is performed, since the foreign matter adhering to the press roll may be mixed into an active material layer, a press quality may decrease.

### SUMMARY OF INVENTION

The present disclosure can be implemented in the following aspects.

According to an illustrative aspect of the present disclosure, an electrode manufacturing apparatus configured to manufacture an electrode in which an active material layer is formed on at least one surface of a metal foil, the electrode manufacturing apparatus includes: a press unit configured to press, by a function surface of a press roller, the metal foil on which the active material layer is formed. The press unit includes the press roller having: a base material; and the functional surface that is formed on an outer circumferential surface of the base material and that is formed with a fine structure imparting a liquid repellency. According to this aspect, since the press roller has the liquid repellency by forming the fine structure, it is possible to prevent the active material or the like from adhering to the press roller, and it is possible to prevent the press quality from deteriorating.

According to the above-related aspect of the present disclosure, the press roller may further include a cured layer having a hardness higher than that of the base material, and the functional surface may be formed in a surface of the cured layer. According to this aspect, by forming the fine structure on the cured layer having a hardness higher than that of the base material, it is possible to improve scratch resistance and wear resistance of the fine structure as compared with the case in which the fine structure is formed on the base material, and thus it is possible to prevent the fine structure from deteriorating. Therefore, it is possible to prevent the liquid repellency from deteriorating due to the deterioration of the press roller, and it is possible to prevent the press quality from deteriorating.

According to the above-related aspect of the present disclosure, the cured layer may be formed of a cemented carbide. According to this aspect, it is possible to prevent the fine structure from deteriorating by forming the cured layer with the cemented carbide having a high hardness.

According to the above-related aspect of the present disclosure, the press roller may further include a coating layer having a surface free energy smaller than that of the base material, and the functional surface ma be covered with the coating layer. According to this aspect, by covering the functional surface with the coating layer having a small surface free energy, the liquid repellency is improved as compared with the case in which the surface in contact with the solvent is the base material, so that it is possible to further prevent the adhesion of the active material and the like. Therefore, it is possible to prevent the press quality from deteriorating.

The present disclosure can be implemented in various aspects, and can be implemented in an aspect of an electrode manufacturing method or the like, in addition to the above-described aspects.

### BRIEF DESCRIPTION OF DRAWINGS

FIG. 1 shows a schematic configuration of an electrode manufacturing apparatus;

FIG. 2 shows a schematic configuration of a coating and drying unit;

FIG. 3 shows a schematic configuration of a press unit; and

FIG. 4 is a cross-sectional view showing a surface structure of a first press roller.

### DESCRIPTION OF EMBODIMENTS

A. First Embodiment:

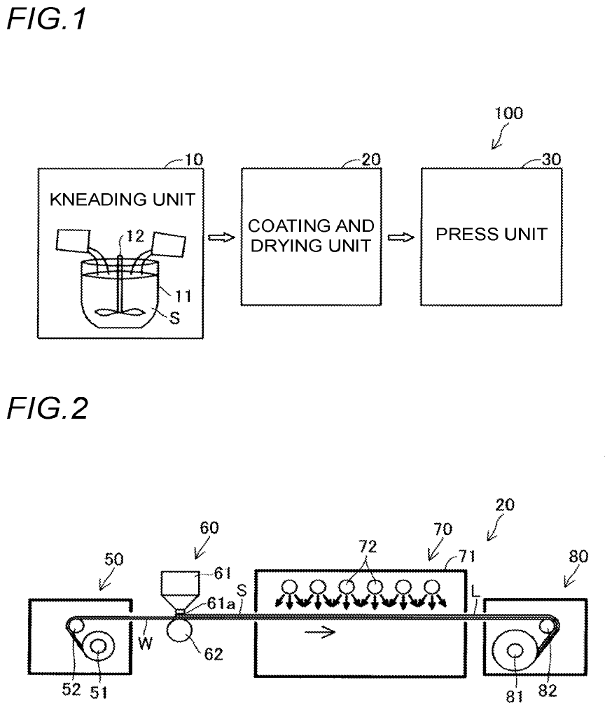

FIG. 1 shows a schematic configuration of an electrode manufacturing apparatus 100. The electrode manufacturing apparatus 100 is configured to, for example, manufacture a metal foil W (FIG. 2) on which an active material layer L (FIG. 2) used as an electrode of a lithium ion secondary battery is formed. The electrode manufacturing apparatus 100 includes a kneading unit 10, a coating and drying unit 20, and a press unit 30. The kneading unit 10 includes a container 11 and a screw 12. In the kneading unit 10, an active material, a conductive additive, a binder, a solvent, and the like are put in the container 11 and kneaded by the screw 12 to produce a slurry-shaped coating material S. Specifically, in a case of a positive electrode, a lithium nickel oxide or the like is used as the active material, acetylene black or the like is used as the conductive additive, polyvinylidene fluoride or the like is used as the binder, and N-methylpyrrolidone or the like is used as the solvent. In a case of a negative electrode, graphite or the like is used as the active material, SBR rubber, polyacrylic acid, or the like is used as the binder, and water or the like is used as the solvent.

In the coating and drying unit 20, the coating material S is applied on the metal foil W and dried. FIG. 2 shows a schematic configuration of the coating and drying unit 20. The coating and drying unit 20 includes an unwinding unit 50, a coating unit 60, a drying unit 70, and a winding unit 80. The unwinding unit 50 includes an unwinding roller 51 and a first transport roller 52. The winding unit 80 includes a winding roller 81 and a second transport roller 82. The metal foil W is wound around the unwinding roller 51. In the case of the positive electrode, the metal foil W is, for example, an aluminum foil, and in the case of the negative electrode, the metal foil W is, for example, a copper foil. The metal foil W delivered from the unwinding roller 51 is bridged between the first transport roller 52 and the second transport roller 82. When each roll of the unwinding unit 50 and the winding unit 80 rotates, the metal foil W is transported from the unwinding unit 50 toward the winding unit 80 and is wound around the winding roller 81. The coating unit 60 and the drying unit 70 are provided between the first transport roller 52 and the second transport roller 82.

The coating unit 60 includes a coating head 61 and a backup roller 62. The coating head 61 has an ejecting port 61a. The coating head 61 is configured to eject the coating material S supplied by a pump (not shown) from the ejecting port 61a. The coating head 61 and the backup roller 62 face each other with the metal foil W interposed therebetween. The coating head 61 is configured to eject the coating material S onto a surface of the metal foil W in contact with the backup roller 62. Accordingly, the coating material S is applied to one surface of the metal foil W.

The drying unit 70 includes a drying chamber 71 and a plurality of hot air generating devices 72. The drying chamber 71 surrounds the metal foil W to be transported. In the drying chamber 71, the plurality of hot air generation devices 72 are arranged along a transport direction of the metal foil W. The hot air generating device 72 is configured to, using a fan (not shown), blow air warmed by a heater (not shown) toward the metal foil W coated with the coating material S. Accordingly, the solvent contained in the coating material S is evaporated, the active material or the like is bound to the metal foil W by the binder, and the active material layer L is formed on the metal foil W. The metal foil W having the active material layer L formed on one surface of the metal foil W is wound around the winding roller 81.

Next, the winding roller 81 on which the metal foil W having the active material layer L formed on the one surface of the metal foil W is wound is used as the unwinding roller 51, and the active material layer L is formed on the other surface of the metal foil W according to the same method as described above. Accordingly, the active material layer L is formed on both surfaces of the metal foil W. The configuration of the coating and drying unit 20 is not limited to the above. For example, the coating head 61 may be provided on each of the both surfaces of the metal foil W to be transported, and the coating material S may be applied to the both surfaces of the metal foil W in one transport.

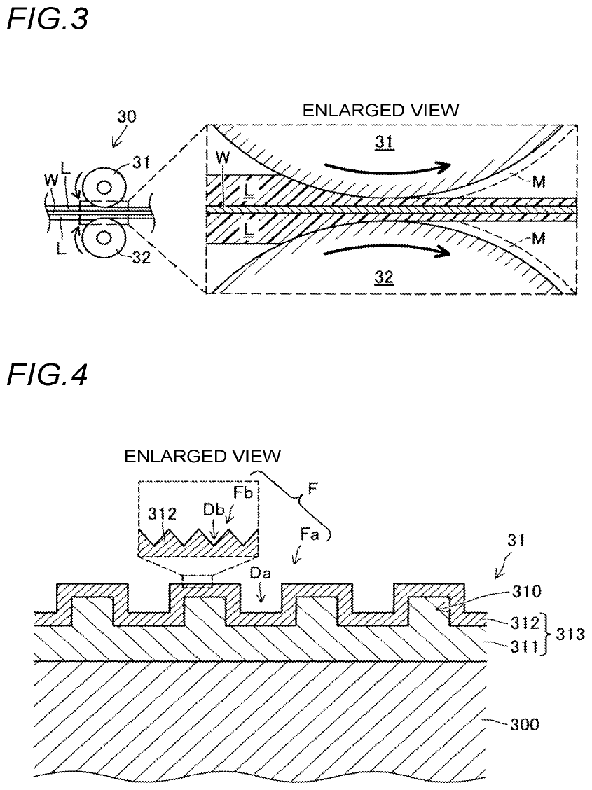

Returning to FIG. 1, in the press unit 30, the active material layer L formed by the coating and drying unit 20 is thinned. FIG. 3 shows a schematic configuration of the press unit 30. A left view of FIG. 3 is a schematic configuration view showing the press unit 30, and a right view of FIG. 3 is an enlarged view showing a part indicated by a broken line in the left view.

The press unit 30 includes a first press roller 31 and a second press roller 32 as press rollers. Each of the first press roller 31 and the second press roller 32 has a cylindrical shape. The first press roller 31 and the second press roller 32 are provided such that rotation shafts thereof are parallel to each other. The metal foil W having the active material layer L formed on the both surfaces of the metal foil W passes between the first press roller 31 and the second press roller 32. The first press roller 31 and the second press roller 32 rotate in mutually opposite directions, so that the metal foil W having the active material layer L formed on the both surfaces of the metal foil W is pressurized from the both surfaces while being transported, and the active material layer L is thinned. Here, in the first press roller 31 and the second press roller 32 that are not devised according to the present disclosure, as illustrated by a broken line in the right view of FIG. 3, a constituent substance M of the active material layer L (hereinafter, simply referred to as a constituent material M) may adhere to the first press roller 31 and the second press roller 32 as a foreign matter. For example, once the constituent substance M adheres to the first press roller 31, the constituent substance M that has previously adhered to the first press roller 31 becomes a nucleus. The constituent substance M further adheres, and the adhering constituent substance M may be deposited. When the pressing is performed by the first press roller 31 or the second press roller 32 to which the constituent substance M adheres, the constituent substance M may be mixed as a foreign matter in the active material layer L, and the press quality may deteriorate. The constituent substance M may enter surfaces of the first press roller 31 and the second press roller 32, and lives of the first press roller 31 and the second press roller 32 may be shortened. Therefore, the inventors have devised the first press roller 31 and the second press roller 32 as described below. Accordingly, the constituent substance M can be prevented from adhering to the first press roller 31 and the second press roller 32, and the press quality can be prevented from deteriorating. The lives of the first press roller 31 and the second press roller 32 can be prevented from being shortened.

FIG. 4 is a cross-sectional view showing a surface structure of the first press roller 31 according to the present embodiment. Since the second press roller 32 has the same configuration as the first press roller 31, a description of a surface structure of the second press roller 32 will be omitted.

The first press roller 31 includes a base material 300 and a surface structure 313. The base material 300 is a cylindrical steel material, and is formed of, for example, SUJ2 or S45C. The surface structure 313 is formed on an outer circumferential surface of the base material 300, and has a functional surface 310 formed with a fine structure F that imparts liquid repellency. The first press roller 31 presses, by the functional surface 310, the metal foil W on which the active material layer L is formed. The functional surface 310 is formed on the first press roller 31, so that it is possible to prevent the constituent substance M from adhering to the first press roller 31. The surface structure 313 is formed by laminating a cured layer 311 and a coating layer 312 in this order. The cured layer 311 has a hardness higher than that of the base material 300, and is formed using a cemented carbide. The functional surface 310 is formed in a surface of the cured layer 311. Accordingly, it is possible to prevent deterioration of the fine structure F due to use. The cured layer 311 is not limited to the cemented carbide, and may be, for example, a layer in which a hard chromium plating layer is formed on a quenched layer. A thickness of the cured layer 311 is, for example, approximately 0.1 mm or more and several mm or less.

The functional surface 310 is covered with the coating layer 312. The coating layer 312 is formed of a material having a surface free energy smaller than that of the base material 300, specifically, for example, diamond-like carbon (DLC), polytetrafluoroethylene (PTFE), or the like. The coating layer 312 is the outermost layer of an outer circumferential surface of the first press roller 31. The coating layer 312 can further prevent the constituent substance M from adhering to the first press roller 31. A thickness of the coating layer 312 is, for example, approximately 0.1 μm or more and several μm or less.

The fine structure F has a first periodic structure Fa and a second periodic structure Fb whose periods are different from each other. Specifically, a minute recess Db that forms the second periodic structure Fb is formed on a surface of the coating layer 312 that forms the first periodic structure Fa. The fine structure F is formed by, for example, laser processing or etching processing. The first periodic structure Fa is a structure in which a groove Da is repeated in a cycle of, for example, several μm or more and several tens of μm or less. A depth of the groove Da is, for example, approximately 0.1 μm or more and several hundred μm or less. The second periodic structure Fb is finer than the first periodic structure Fa, and is a structure in which the recess Db is repeated, for example, in a submicron cycle. A depth of the recess Db is smaller than approximately 1 μm, which is the minimum value of a particle diameter of a substance contained in the coating material S. Here, specifically, the substance contained in the coating material S is an active material, or an active material and a conductive additive when the conductive additive is contained in the coating material S.

A material of the coating layer 312 is determined based on the Young's equation. The Young's equation represents relation among a contact angle θ of droplets on a smooth solid surface, a surface free energy γ_{S} of a solid, a surface free energy γ_{L} of a liquid, and an interfacial tension γ_{SL} between the solid and the liquid. The Young's equation is shown as the following equation (1).

γ_{S}=γ_{L}·cos θ+γ_{SL} Equation (1)

In general, when the surface free energy γ_{S} of the solid is smaller than the surface free energy γ_{L} of the liquid, the contact angle θ becomes large, and the liquid repellency is improved. The surface free energy γ_{S} of the solid, the surface free energy γ_{L} of the liquid, and the interfacial tension γ_{SL} between the solid and the liquid depend on a material of the solid and a material of the liquid. In the present embodiment, the material of the liquid is a solvent contained in the coating material S, and the solvent is determined based on a type of the battery to be produced. It is considered that most of the solvent evaporates in the drying unit 70 but a small amount of the solvent remains in the active material layer L. It is considered that the solvent exuded from a binder adheres to the first press roller 31 and the second press roller 32 due to a pressing force at the time of the pressurization performed by the first press roller 31 and the second press roller 32. In the present embodiment, a material whose surface free energy γ_{S} is small is used to form the coating layer 312. Specifically, as described above, DLC, PTFE, or the like whose surface free energy γ_{L} is smaller than the surface free energy γ_{S} of the substrate 300 is used. Accordingly, the liquid repellency of the functional surface 310 can be improved, and the constituent substance M can be prevented from adhering to the first press roller 31 and the second press roller 32.

It is known that a rough surface of a substance on which a fine uneven structure is formed has higher liquid repellency than a smooth surface. As a model representing relation between a roughness of a surface and a degree of liquid repellency, there are Wenzel model and Cassie-Baxter model. The Wenzel model assumes a state in which a liquid is mixed in the recess, and the Cassie-Baxter formula is a model that assumes a state in which no liquid is mixed in the recess.

An apparent contact angle θa in the rough surface in the Wenzel model is expressed by the following equation (2).

cos θa=r·cos θ Equation (2)

The contact angle θ is a contact angle of the droplets on the smooth solid surface represented by the above equation (1). r is a roughness factor, is a ratio of an actual surface area to an apparent surface area of the rough surface, and takes a value larger than 1. The roughness factor r is calculated by the following equation (3).

r=rb/ra Equation (3)

rb is the actual surface area of the rough surface, and ra is the apparent surface area of the rough surface.

An apparent contact angle θb in the rough surface in the Cassie-Baxter model is expressed by the following equation (4).

cos θb=f1·cos θ−f2 Equation (4)

The contact angle θis the contact angle of the droplets on the smooth solid surface represented by the above equation (1). f1 and f2 are surface integrals of the solid in contact with the liquid, f1 is the surface integral of an upper surface of a convex portion of the rough surface in contact with the liquid, and f2 is the surface integral of a surface of the air in the recess in contact with the liquid. f1 and f2 satisfy the following equation (5).

f1+f2=1 Equation (5)

Whether the recess in the uneven structure is immersed, that is, whether the Wenzel model or the Cassie-Baxter model is followed, is considered to be influenced by various factors such as a shape of the rough surface. In the present embodiment, a specific structure of the first periodic structure Fa, for example, a depth of the groove Da, a width of the groove Da, a pitch of the groove Da, and the like are determined experimentally such that the apparent contact angle θa or the apparent contact angle θb becomes large. Since the first periodic structure Fa is formed on the first press roller 31 and the second press roller 32 and has a rough surface, the liquid repellency of the first press roller 31 and the second press roller 32 can be improved as compared with a case in which the first periodic structure Fa has a smooth surface. Therefore, it is possible to prevent the constituent substance M from adhering to the first press roller 31 and the second press roller 32.

It is known that, theoretically, a fractal surface having an infinite surface area is present in nature, and the fractal surface exhibits super hydrophobicity. A fractal figure has self-similarity, and a fractal dimension D is used as an index representing the fractal figure. The fractal dimension D is expressed by an equation (6) when the fractal dimension D is constituted by b figures obtained by reducing the fractal dimension D to one of a.

D=log b/log a Equation (6)

The uneven surface with 2<D<3 is called a fractal surface. It is known that the liquid does not enter the recess on the fractal surface and the liquid repellency is further improved. In the present embodiment, the second periodic structure Fb that is repeated in the submicron cycle is formed on the surface of the coating layer 312. Accordingly, the surface area of the coating layer 312 becomes large, and the liquid repellency can be further improved. Therefore, it is possible to prevent the constituent substance M from adhering to the first press roller 31 and the second press roller 32.

According to the above-described embodiment, since the first press roller 31 and the second press roller 32 have the functional surface 310 on which the fine structure F that imparts the liquid repellency is formed, the constituent substance M can be prevented from adhering to the first press roller 31 and the second press roller 32, and the press quality can be prevented from deteriorating. The first press roller 31 and the second press roller 32 include the cured layer 311 having a hardness higher than that of the base material 300, and the functional surface 310 is formed in the surface of the cured layer 311. Accordingly, it is possible to improve scratch resistance and wear resistance of the fine structure F as compared with the case in which the fine structure F is formed on the base material 300, and thus it is possible to prevent the fine structure F from deteriorating. Since the cured layer 311 is formed of a cemented carbide, it is possible to improve the scratch resistance and the wear resistance of the fine structure F. The first press roller 31 and the second press roller 32 include the coating layer 312 having a surface free energy smaller than that of the base material 300, and the functional surface 310 is covered with the coating layer 312. Accordingly, the liquid repellency is improved as compared with the case in which the surface in contact with the solvent is the base material 300, so that it is possible to further prevent the adhesion of the constituent substance M and the like. Therefore, it is possible to prevent the press quality from deteriorating.

B. Other Embodiments:

Another embodiment B1: in the above-described embodiment, the functional surface 310 is formed on the outer circumferential surface of the base material 300. The functional surface 310 is formed in the surface of the cured layer 311, and the functional surface 310 is covered with the coating layer 312. The present disclosure is not limited to this configuration, and the functional surface 310 may not be covered with the coating layer 312. By forming at least the fine structure F that imparts the liquid repellency, it is possible to prevent the constituent substance M from adhering to the first press roller 31 and the second press roller 32. In the case of producing the negative electrode, water is used as the solvent. Since water has a surface free energy larger than that of the organic solvent, even if the functional surface 310 is not covered with the coating layer 312, sufficient liquid repellency is imparted by the fine structure F. Therefore, the coating layer 312 may not be provided in many cases. According to the configuration in which the functional surface 310 does not include the coating layer 312, manufacturing cost for forming the coating layer 312 can be reduced.

Another embodiment B2: in the first press roller 31 and the second press roller 32, the cured layer 311 is formed on the outer circumferential surface of the base material 300, and the functional surface 310 is formed in the surface of the cured layer 311. The present disclosure is not limited to this configuration, and the functional surface 310 may be formed in the surface of the base material 300 without providing the cured layer 311. The surface of the base material 300 can have liquid repellency by forming the functional surface 310. Therefore, the adhesion of the constituent substance M and the like can be prevented, and the press quality can be prevented from deteriorating.

Another embodiment B3: in the above-described embodiment, the first periodic structure Fa and the second periodic structure Fb are formed. The present disclosure is not limited thereto, and only one of the first periodic structure Fa and the second periodic structure Fb may be formed. At least one of the first periodic structure Fa and the second periodic structure Fb is formed, so that the liquid repellency can be improved as compared with the case in which the first press roller 31 and the second press roller 32 have smooth surfaces. Therefore, the adhesion of the constituent substance M and the like can be prevented, and the press quality can be prevented from deteriorating.

Another embodiment B4: in the above-described embodiment, the groove Da is periodically formed as the first periodic structure Fa. A shape of the first periodic structure Fa is not limited to the groove. For example, the shape may be a groove shape in which a surface is a curved surface, or may be a shape in which a protrusion is formed on the surface. A shape of the protrusion may be, for example, a cylindrical shape or a conical shape.

Another embodiment B5: in the above-described embodiment, the press unit 30 is configured to press the metal foil W on which the active material layer L is formed on both surfaces of the metal foil W. The metal foil W pressed by the press unit 30 is not limited to the metal foil W on which the active material layer L is formed on the both surfaces, and may be the metal foil W on which the active material layer L is formed only on one surface of the metal foil W.

Another embodiment B6: the electrode manufacturing of the lithium ion secondary battery is exemplified. However, the present disclosure is not limited to the lithium ion secondary battery, and can also be applied to, for example, a roller used in a manufacturing process of another power storage device such as a lithium ion capacitor. For example, the present disclosure can also be applied to a roller used for forming a powder such as wheat flour, calcium, or printing paint into, for example, a flat shape.

The present disclosure is not limited to the above-described embodiments, and can be implemented by various configurations without departing from the gist of the present disclosure. For example, the technical features in the embodiments corresponding to the technical features in the aspects described in the Summary may be replaced or combined as appropriate in order to solve a part or all of the above-described problems or in order to achieve a part or all of the above-described effects. Any of the technical features may be omitted as appropriate unless the technical feature is described as essential in the present specification.

What is claimed is:

1. An electrode manufacturing apparatus configured to manufacture an electrode in which an active material layer is formed on at least one surface of a metal foil, the electrode manufacturing apparatus comprising:
a press unit configured to press, by a function surface of a press roller, the metal foil on which the active material layer is formed,
wherein the press unit includes the press roller having: a base material; and the functional surface that is formed on an outer circumferential surface of the base material and that is formed with a fine structure imparting a liquid repellency.

2. The electrode manufacturing apparatus according to claim 1,
wherein the press roller further includes a cured layer having a hardness higher than that of the base material, and
wherein the functional surface is formed in a surface of the cured layer.

3. The electrode manufacturing apparatus according to claim 2,
wherein the cured layer is formed of a cemented carbide.

4. The electrode manufacturing apparatus according to claim 1,
wherein the press roller further includes a coating layer having a surface free energy smaller than that of the base material, and
wherein the functional surface is covered with the coating layer.
